(19) United States
(12) Patent Application Publication
(10) Pub. No.: US 2008/0220133 A1
(43) Pub. Date: Sep. 11, 2008

(54) FOOD SANITATION SYSTEM

(76) Inventors: Gary Bruce Carman, Reno, NV (US); Stephen Karl Wirtz, Sparks, NV (US)

Correspondence Address: IAN F. BURNS & ASSOCIATES, P.O. BOX 71115, RENO, NV, 89570, US

(21) Appl. No.: 11/682,297

(22) Filed: Mar. 5, 2007

(51) Int. Cl. A23L 3/3418; A23L 3/3409

(52) U.S. Cl. 426/320; 99/467

(57) ABSTRACT

The present invention generally describes a method and apparatus that can be used to significantly reduce the microbiological load of temperature sensitive foods and supplements. The active gaseous components of the system are carbon monoxide and ozone which is continually applied under a constant pressure, humidity, and temperature in a sealed room. The continuous gas flow containing carbon dioxide and oxygen is modified by using a tuned corona discharge generator and further modified by passing the gas stream through the ozone conversion module (OCM). The resultant gas flow contains a ratio of CO₂/CO/O₃ at a ratio of 15:5:1 which is extremely toxic to most yeast, molds, and pathogenic bacteria. The product being treated is typically exposed for several hours to this flowing gas mixture which is also held at a relative humidity of 98 to 100%. The temperature of the sealed treatment room is also held at a cool temperature between −5° and 15° C. to minimize damage to the temperature sensitive food product. A pressure differential between 300 and 650 mbar is also maintained throughout the process between the sealed treatment room and the generation equipment to maintain the proper flow of the gas stream.

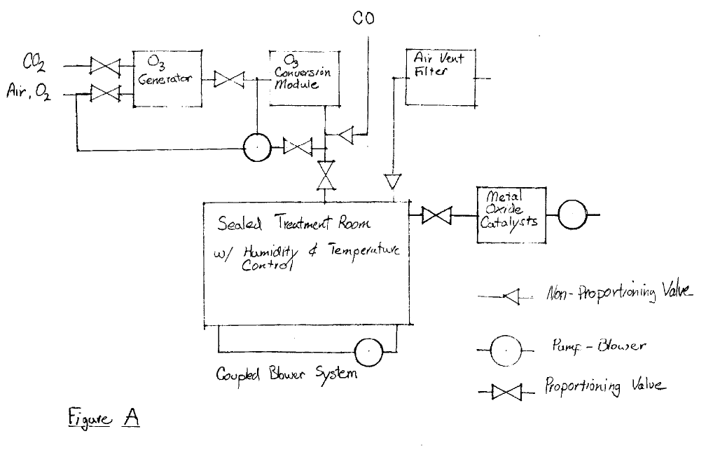

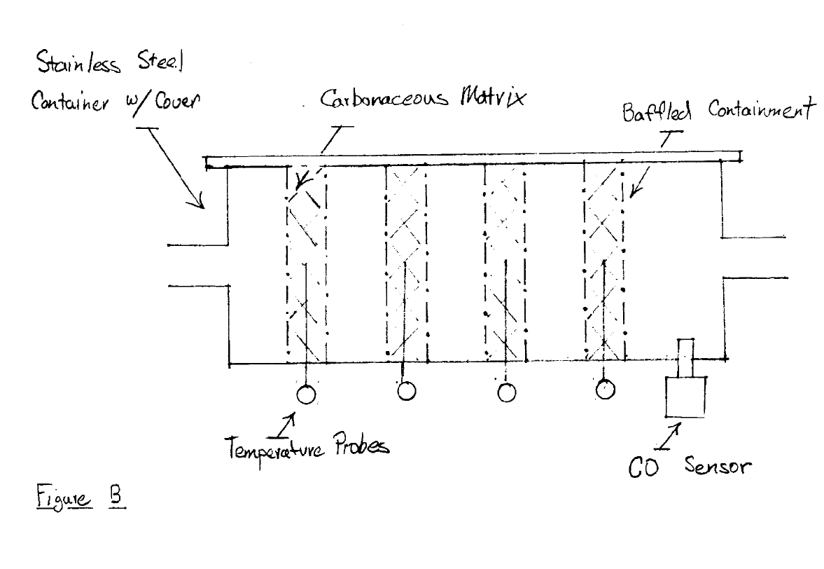

### BACKGROUND OF THE INVENTION

### Field of the Invention

The present invention generally describes a method and apparatus that can be used to significantly reduce the microbiological load of temperature sensitive foods and food supplements. The active components of this gaseous treatment are carbon monoxide (CO) and ozone (O₃) which offer many advantages over traditional fumigants such as methyl bromide, sulfur dioxide, chlorine dioxide, irradiation, and thermal treatments. The present invention does not produce any undesirable residues and minimizes any damage to the food most often associated with the other fumigation systems. By maintaining a predominant quantity of carbon monoxide, relative to the ozone content, the oxidative stress of the gas stream is greatly reduced. The chemistry of this system is very unique since two bacteriostatic and fungistatic gases are utilized that can coexist in the gas stream. The fact that carbon monoxide is a strong reducer and ozone is a strong oxidizer, the reactivity of the gas stream with the food substrate is greatly reduced. Therefore, the absolute quantity of both active components needed to maintain the efficacy of the treatment is greatly reduced when compared to traditional fumigation treatments. The efficacy of carbon monoxide use as a fungistat and bacteriostat has been well documented when used as a fumigant at relatively high doses (i.e. 60-90%). The present invention offers a unique advantage over previous carbon monoxide fumigation systems in that the synergy of the active gases also reduces the contact time to commercially viable exposure times. Since these treatments must be performed in a sealed room or enclosure, the treated product must be rotated in as short a time as possible for cost considerations. In addition to the gas tight room, this treatment space must also be held at freezing or near freezing temperatures which also adds cost to the maintenance of this space. For about the past decade, a number of widely utilized fumigants have come under attack for environmental, worker exposure, undesirable residues, and consumer resistance issues. Methyl bromide has been identified as an ozone depleting compound and ethylene oxide as a mutagen and carcinogen. Phosphine gas is being challenged due to residue issues as well as insect resistance concerns. Sulfur dioxide has long been identified as a common human allergen and is being regulated or banned by regulatory agencies around the world. Whilst heat and steam techniques remain the most widely used and most effective sterilant, a number of heat sensitive foods and food supplements simply cannot be treated in this manner. The present invention avoids these downfalls of the more traditional materials and procedures in totality. A few of the more modern approaches have utilized high energy particles to treat foods. Radioactive gamma sources, electron beam, X-ray, plasma emission clouds, and electron gun emitters have been used with varying success due to product damage as well as the high price of commercialization.

Carbon monoxide has traditionally been used to treat raw meat products to enhance the color during storage by binding the hemoglobin constituent with the carbon monoxide and thereby avoiding the formation of myoglobin Abrowning@ reactions. Some consumer and regulatory agency resistance has developed against this practice since it may present a misrepresentation of the actual quality of the meat. It should be noted that very small quantities of carbon monoxide are required to achieve the desired bright red color of the treated meat, hence, no bacteriostatic nor fungistatic effects are realized. A number of modified atmosphere packaging (MAP) schemes have been developed to utilize this phenomenon for packaged meats. The present invention would not be suitable for the treatment of muscle foods due to the high levels of carbon monoxide used as well as the presence of ozone in the system that would promote off odors and flavors due to the oxidation of the lipid components of the meat. In addition, MAP gas mixtures are not utilized in the present invention nor is the treatment applicable to a packaging line due to worker exposure concerns.

### SUMMARY OF THE INVENTION

The method and apparatus of the present invention consists of a system to uniformly expose food and food supplements to a gaseous stream that contains carbon monoxide and a lesser concentration of ozone to create a bacteriostatic and fungistatic environment inside of a sealed room for a relatively short duration. The gas stream is created by using a properly tuned, low to medium frequency corona discharge ozone generator. By utilizing a properly tuned corona discharge generator, it is possible to utilize carbon dioxide as a primary feed gas and directly produce a significant quantity of carbon monoxide and a lesser amount of ozone by the molecular cleaving of the carbon dioxide. The tuning process is achieved by utilizing one of the harmonic frequencies of the resonance frequency of carbon dioxide. The AC=O stretch@ frequency for the carbonyl group is 1.63 to 1.78 Ghz. Therefore, the use of low frequency, high potential harmonics of this Astretch@ frequency will cleave the carbon dioxide molecule. The ideal frequency range falls between the 17^{th} and 18^{th} harmonics, or 13.008 to 6.504 KHz to yield the greatest carbon monoxide production as well as the greatest ozone production. This is important since the major portion of the ozone will be converted to produce greater quantities of carbon monoxide in the Ozone Conversion Module (OCM). By controlling the initial gas mixture being fed to the corona discharge generator, the appropriate amount of carbon monoxide and ozone are generated. This gas stream is then further modified by a controlled chemical reaction within the proprietary OCM which converts the majority of the ozone to carbon monoxide. In addition, a commercially prepared compressed source of CO is also incorporated to boost the initial gas concentration during the warm up period of the OCM. This is a time and cost saving step to rapidly meet the treatment parameters within the sealed treatment room. This CO source may also be utilized in the event the CO concentration is not fully met by the OCM during the process. This modified gas stream is then directed to the sealed treatment room via a series of proportioning valves to carefully maintain the pressure differential. The pressure differential is utilized to assure the proper flow of the gas stream through the corona discharge generator and the OCM to the sealed treatment room. To maintain the proper conversion rate in the OCM, it is crucial that this pressure differential be maintain lest the ozone to carbon monoxide reaction is lost and the carbonaceous material in the OCM will be rapidly consumed. The pressure differential is preferably maintained between 300 and 650 mbar to maintain the proper and controlled conversion in the OCM. A discharge modulating valve is coupled with the intake modulating valve to maintain a constant pressure in the sealed room. The discharged gas stream is catalytically treated using commercially available metal oxide catalysts to break down any remaining carbon monoxide and ozone before said gas stream is discharged into the atmosphere to avoid any worker exposure and environmental concerns. A central process control unit is used to control the apparatus gas flows as well as the distinct phases of the process.

The process is broken down into four distinct phases, the first being the establishment of the initial conversion phase (IC phase). During this phase, the corona discharge generator is turned on and the gas flows of carbon dioxide and oxygen, or dry air, are initiated through the cell(s) of the corona discharge generator. A portion of this flow may be recycled through the corona discharge generator to assist in establishing the proper conversion temperature which must be gradually established in the OCM. This phase is also important to purge out any undesirable gases that may have remained in the system from the previous process. The remainder of the gas stream is diverted to the sealed treatment room. Once the proper OCM temperature is established, phase two is initiated. Phase two is the establishment of the differential pressure gas flow (DP phase). The bypass valve is closed and the entire gas stream is directed to the sealed treatment room. A discharge pump or fan may be used to assure a stable pressure within the room to promote the flow of the gas stream out of the room and through the catalytic bed. The controller system will modulate the gas infeed valves as well as the input and discharge modulating valves of the sealed treatment room. This is a critical step in the process to balance the gas flow and assure a proper ozone generation and it subsequent controlled conversion to carbon monoxide within the OCM. The third phase is the product exposure phase (PE phase). This phase represents the greatest time interval of the process. The pressure differential is held constant and the gas flow is also held relatively constant to maintain the balance. The incorporation of either internal or externally coupled blowers or fans can be utilized to assure an even distribution of the gas throughout the sealed treatment room. During this phase, the concentration of the carbon monoxide is allowed to rise in the sealed treatment room to between 0.1% and 10% by volume depending on the commodity being treated. Most preferably, the carbon monoxide concentration will peak in the 4% to 6% range. Trace amounts of ozone will also be present during this phase due incomplete conversion by the OCM. An expected ratio of CO₂/CO/O₃ at 15:5:1 is ideal for most food products. The final phase is the gas venting phase (GV phase). At the termination of the PE Phase, the gas stream through the corona discharge generator and the OCM is stopped where the pressure is slowly reduced until it at atmospheric pressure. The pressure differential is ceased and the discharge pump is utilized to pull filtered atmospheric air through the sealed treatment chamber as well as through the catalytic bed. Once the internal carbon monoxide sensor indicates the gas level is sufficiently low as to be safe for worker exposure, the cycle is terminated and the door(s) are opened for product removal. Additional safety systems and monitors may also be used such as visual and audible alarms.

The ideal treatment temperature is between −5° and 15° C. to minimize any damage to the temperature sensitive food products. Since many of the target foods, such as fresh fruits and vegetables, are traditionally stored at these temperatures, it is ideal to maintain the cold chain during the storage and treatment of these products. In addition, the reactivity of the residual ozone is minimized, thereby eliminating any phytotoxic issues. The relative humidity is also maintained between 98% and 100% within the sealed treatment room during this process to avoid any dehydration of these food products.

The preferred embodiment of the OCM consists of a dry carbonaceous matrix contained in a baffled, stainless steel containment structure. The OCM must be constructed to assure that a minimum of back pressure is generated and remains a constant for the life of the unit. Since the carbonaceous matrix is slowly consumed, the OCM must be considered a time rated part. A temperature and carbon monoxide sensor is also employed within the OCM to monitor its proper operation. A secondary embodiment of the OCM utilizes an aqueous carbonaceous matrix wherein the gas stream is aspirated through the said matrix. The advantages of this embodiment is the ease of control versus the dry system. In addition, this system also helps to humidify the gas stream to help maintain the relative humidity of the sealed treatment room. The disadvantage of the aqueous system is a reduced rate of conversion.

### BRIEF DESCRIPTION OF THE DRAWINGS

Figure A is a schematic of the entire system including the required valves and components.

Figure B is a detailed diagram of the Ozone Conversion Module (OCM).

What is claimed is:

1. A method for treating temperature sensitive foods and food supplements utilizing a gas stream containing carbon monoxide and a residual amount of ozone in a sealed treatment room while controlling the differential pressure, temperature, relative humidity, and gas conversion rate.

2. The method of claim 1, wherein the food product or food supplement to be treated for bacterial or fungal control comprised of, but not limited to, fresh fruit, vegetables, fortification mixtures, coloring agents, filtering agents, and other herbaceous plant products.

3. A method of claim 1, further comprising a multiphase process consisting of:
a. Initial Conversion Phase
b. Differential Pressure Gas Flow Phase
c. Product Exposure Phase
d. Gas Venting Phase

4. The method of claim 3, wherein the product exposure phase will have a duration of 15 minutes to 20 hours.

5. The method of claim 1, wherein a tuned, low frequency, corona discharge ozone generator is utilized to generate an initial source of carbon monoxide and ozone by using a gas source of carbon dioxide and oxygen.

6. The method of claim 5, wherein a gas flow from a corona discharge generator comprising carbon dioxide, carbon monoxide, oxygen, and ozone, in relative concentrations, are carefully regulated through a unique ozone conversion module (OCM) which is used to convert the vast majority of the ozone in the gas stream to carbon monoxide which is further used as a bacteriostatic and fungistatic agent.

7. The method of claim 6, wherein the initial gas stream from the OCM is partially recycled through the OCM until the appropriate conversion temperature between 51° and 66° C. is achieved within the OCM.

8. The method of claim 1, wherein a differential pressure between 300 and 650 mbar is established and maintained between the OCM discharge proportioning valve and the sealed treatment room to promote the flow of the treatment gas as well as maintain the proper parameters for the gas conversion with in the OCM.

9. A method of claim 8, wherein a fan or exhaust pump located on or in the sealed treatment room is utilized to maintain said pressure differential.

10. A method of claim 9, wherein the gas stream is first directed through a metal oxide catalytic bed to completely convert any remaining carbon monoxide and ozone prior to being exhausted into the atmosphere.

11. The method of claim 1, wherein the converted gas stream is directed into the sealed treatment room and brought into direct contact with the temperature sensitive food or food supplement items to be treated for microbiological issues.

12. The method of claim 11, wherein the temperature is maintained between −5o and 15o C to protect the temperature sensitive food or food supplements.

13. The method of claim 11, wherein the atmosphere within the sealed treatment room is maintained at a relative humidity between 98% and 100%.

14. The method of claim 11, wherein the atmosphere within the sealed treatment room will maintain a ratio of approximately 15:5:1 of carbon dioxide, carbon monoxide, and ozone respectively during the product treatment phase.

15. The apparatus for the treatment of temperature sensitive food and food supplements utilizing a gas stream of carbon monoxide and residual ozone in a sealed treatment room while controlling the temperature, relative humidity, differential pressure, and gas conversion rate.

16. The apparatus of claim 15, wherein a tuned, low frequency, corona discharge ozone generator is used as the principal energy source to produce carbon monoxide and ozone from an input source comprised of carbon dioxide and oxygen.

17. The apparatus of claim 15, wherein a unique ozone conversion module is utilized to convert the gas stream from the discharge of the tuned, corona discharge ozone generator from an ozone rich mixture to a carbon monoxide rich mixture with a residual amount of ozone.

18. The apparatus of claim 17, wherein a gas bypass system is utilized to recycle a portion of the gas stream from the discharge of the OCM to assure the establishment of the proper conversion temperature.

19. The apparatus of claim 17, wherein a unique blend of carbonaceous compounds are utilized to convert the plurality of oxygen radicals and allotrophes to carbon monoxide under a very controlled gas flow, gas composition, and temperature.

20. The apparatus of claim 15, wherein the OCM is constructed and insulated as to assure the nominal operating temperature between 51° and 66° C. is maintained during the operation of the apparatus.

21. The apparatus of claim 17, wherein the OCM will produce carbon monoxide concentrations between 0.1% and 10% by volume of the gas stream.

22. The apparatus of claim 15, wherein a series of proportioning valves control the gas stream to the OCM, gas bypass system, sealed treatment room, and the exhaust fan discharge to maintain the appropriate pressure differential of 300 mbar to 650 mbar throughout the entire system.

23. The apparatus of claim 22, wherein a fan or exhaust pump is used in conjunction with a proportioning valve to allow venting of the sealed treatment room.

24. The apparatus of claim 23, wherein the gas stream is first directed through a metal oxide catalytic bed to eliminate any residual carbon monoxide and ozone.

25. The apparatus of claim 15, wherein a means is provided to maintain the interior temperature of the sealed treatment room between a range of −5° to 15° C.

26. The apparatus of claim 15, wherein a water mister or contactor is provided to maintain the relative humidity of the interior of the sealed treatment room between 98% and 100%.

27. The apparatus of claim 15, wherein a valve controlled source of commercially compressed CO is available to boost the concentration of said gas to meet the operating parameters.
